(19) United States
(12) Patent Application Publication
(10) Pub. No.: US 2011/0010633 A1
(43) Pub. Date: Jan. 13, 2011

(54) SYSTEMS AND METHODS FOR MONITORING AND MANAGEMENT OF NETWORK SECURITY SYSTEMS

(75) Inventors: Alfred R. Richmond, Severna Park, MD (US); Peter W. Rung, Lutz, FL (US); David J. Boubion, Tampa, FL (US); Mary Claire Ryan, Burr Ridge, IL (US)

Correspondence Address: SCHERRER PATENT & TRADEMARK LAW P.C., 17 E. CRYSTAL LAKE AVE, CRYSTAL LAKE, IL, 60014, US

(73) Assignee: I.D. RANK SECURITY INC., Largo, FL (US)

(21) Appl. No.: 12/810,007

(22) PCT Filed: Dec. 22, 2008
(86) PCT No.: PCT/US2008/014033

§ 371 Date: Jun. 21, 2010

Related U.S. Application Data
(60) Provisional application No. 61/008,631, filed on Dec. 20, 2007.

(51) Int. Cl. G06F 15/177

(52) U.S. Cl. 715/736

(57) ABSTRACT

Systems and methods of the present invention monitor and manage network devices on a network. More specifically, network architecture is graphically represented in 3-dimensional space. Moreover, the 3-dimensional architecture of the network is mapped and/or overlaid onto a 3-dimensional graphical representation of physical space and displayed on a visual display. In addition, intrusion detection is graphically represented onto the three-dimensional graphical representation of the network architecture.

The present invention claims priority to U.S. Provisional Patent Application No. 61/008,631, filed Dec. 20, 2007, which is expressly incorporated herein in its entirety.

### BACKGROUND OF THE INVENTION

The present invention generally relates to the monitoring and management of a computer network. More specifically, the present invention relates to the monitoring and management of a computer network, wherein the architecture of the computer network is graphically represented 3-dimensionally. Moreover, the present invention relates to the monitoring and management of the network, wherein the 3-dimensional architecture of the network is mapped, overlaid or otherwise incorporated into a graphical representation of physical space and displayed on a visual display. In addition, the present invention relates to monitoring and management of the computer network, wherein a security event is graphically represented on the three-dimensional graphical representation of the computer network.

It is generally known to provide a computer network whereby multiple computing devices, such as computers, servers, databases and the like are interconnected to each other. The first computer network is believed to have been developed by the Advance Research Projects Agency (ARPA), which designed the “Advanced Research Projects Agency Network” (ARPANET) for the United States Department of Defense in the late 1960's and early 1970's. ARPANET is believed to be the first widely used computer network.

Today, computer networks are prevalent throughout the world, and generally can be classified by their scale. For example, a Local Area Network (LAN) typically involves a small, discrete number of computers that are interconnected to each other within the same geographical location, such as within a home, office, building or small group of buildings. A Wide Area Network (WAN) is a computer network that covers a broad area and can include a network whose communications links cross metropolitan, regional, or national boundaries. The largest and most well-known example of a WAN is the Internet. Another example of a computer network is a Metropolitan Area Network (MAN), which involves a large number of computer networks that span a city. A Personal Area Network (PAN) typically involves a very small number of computing devices that are interconnected together, typically within the same room or within very short distances. Examples may include a wired or wireless interconnection between a computer and a printer, a telephone, a personal digital assistant, a music player, and/or the like. An additional type of network is a Virtual Private Network (VPN), which is a computer network in which some of the links between nodes are carried by open connections or virtual circuits in some larger network (e.g., the Internet) instead of by physical wires or direct wireless connections.

Once computing devices, such as computers, servers, databases and the like, are networked together, maintaining security of information contained on the computing devices becomes difficult. Typically, with a single computing device, computer inputs and outputs are easily controlled and generally involve a small, discrete number of access points. For example, a so-called “desktop computer” typically includes a computer keyboard and mouse for inputting information or obtaining access to the computer. However, once multiple computing devices (nodes) are added to a computer network or otherwise networked together, multiple access points are provided. Wired computer networks typically offer a higher level of security than wireless networks, since wired computer networks require access via a physical wire or cable, into a node for obtaining access to information contained on the network. Wireless networks, however, provide malicious intruders with higher levels of accessibility, since physical wire or cable access into the network is not necessary, and intruders can, therefore, obtain access to the network over distances without typically being seen, heard or otherwise physically detected.

Intrusion detection, in the context of computer network systems, is the act of detecting actions that attempt to compromise the confidentiality, integrity or availability of a computer network. Intrusion detection can be performed manually or automatically. Manual intrusion detection typically includes an individual examining log files or other evidence for signs of intrusions, including network traffic. A system that performs automated intrusion detection is typically called an Intrusion Detection System (IDS). An IDS can either monitor system calls or logs for signs of intrusion, or monitor the flow of network packets through the computer network. Modern IDSs are usually a combination of these two approaches. In addition, intrusion detection may include identifying patterns of traffic or application data throughout the network that are presumed to be malicious based on the particular pattern, or may include comparing activities against a “normal” baseline. Typically, when a probable intrusion is discovered by an IDS, a typical action would be to log the relevant information to a file or database and generate an alert to notify an individual of the suspected intrusion. Typically, this alert involves generating an e-mail or a message that is sent to an individual's computer, cell phone or mobile device.

Another form of detection is known as “extrusion detection” and involves the monitoring or outbound data or information. Extrusion detection techniques focus primarily on the analysis of system activity and outbound traffic in order to detect malicious users, malware or network traffic that may pose a threat to the security of neighboring systems.

As noted above, an intrusion detection system typically logs the suspected intrusion into a file or database for an individual to review and/or analyze. The logs generated by an IDS typically contain a plurality of textually-based data strings. By analyzing the information contained in the logs, an individual can obtain particular information about the suspected security breach. For example, information in the logs can inform an individual of where and when the intrusion attempt or attempts occurred. Other information may include, for example, internal users scanning or attacking outside systems or otherwise having malicious code on their systems, including worms, trojans, viruses and/or the like. Moreover, security breaches determined by analyzing logs may include invalid users that have obtained access to the network, users accessing what they should not access and/or users accessing when they should not access. And, logs may simply inform an individual of multiple failed login attempts.

Oftentimes, however, typical intrusion detection systems do not provide information that is easy for an individual to understand. For example, logs are typically reviewed by network technicians that are specifically trained to review and/or analyze the logs. Moreover, reviewing logs for patterns of malicious attacks on a network typically takes a large amount of time. If a large number of attacks occur on a network system, it may be difficult for an individual to review and/or analyze the logs in an efficient manner to prevent the occurrence of the intrusion.

It is also important to determine where an attack occurs on a network so that future attacks may be prevented. Not only is it difficult for an individual to review and/or analyze the large amount of data contained within the logs, it is difficult to determine where a malicious attack occurs on a network, especially on a very complicated network involving large numbers of computing devices. Moreover, if a large number of attacks are occurring on a network, it is often difficult to track and determine where these attacks are occurring.

A need, therefore, exists for systems and methods for efficiently displaying and/or viewing network information from both an intrusion and/or an extrusion point of view, thereby displaying information regarding the network information in a manner that has contextual meaning to the individual. A further need exists for systems and methods that utilize a polling mechanism to determine a network architecture. In addition, a need exists for systems and methods for frequent checking of readiness status. Moreover, a further need exists for a polling mechanism that determines an initial status of a network and a real-time status of a network and all devices connected to the network. A still further need exists for systems and methods for storing the information collected relating to the status of the network, whether initial or real-time, thereby allowing for efficient retrieval of the information for processing the data. A further need exists for a visual implementation of the information so that the information may be quickly and efficiently analyzed by an individual. Moreover, a need exists for a system and a method for generating a 3-dimensional visual representation of a network architecture based on the location of nodes within the network, including computing devices such as computers, servers, routers, databases and the like.

Moreover, a need exists for importing information relating to the physical structure of a building or buildings, or other physical locations containing the network and mapping and/or overlaying the 3-dimensional visual representation of the network architecture over the visual representation of the physical structure of the building or buildings, or other physical space.

### SUMMARY OF THE INVENTION

The present invention generally relates to the monitoring and management of a computer network. More specifically, the present invention relates to the monitoring and management of a computer network, wherein the architecture of the computer network is graphically represented 3-dimensionally. Moreover, the present invention relates to the monitoring and management of the network, wherein the 3-dimensional architecture of the network is mapped, overlaid or otherwise incorporated into a graphical representation of physical space and displayed on a visual display. In addition, the present invention relates to monitoring and management of the computer network, wherein a security event is graphically represented on the three-dimensional graphical representation of the computer network.

To this end, in an embodiment of the present invention, a method for graphically representing a computer network is provided. The method comprises the steps of: providing a 3-dimensional modeler; inputting information about a physical space into the modeler for graphically representing the physical space in 3-dimensions; providing a computer network comprising a plurality of nodes, the plurality of nodes residing within the physical space; polling the computer network to obtain information relating to the physical location of the nodes within the physical space; and generating a combined 3-dimensional graphical representation of the physical space and the computer network.

In an embodiment of the present invention, the method comprises the step of showing the combined 3-dimensional graphical representation of the physical space and the computer network on a display.

In an embodiment of the present invention, the method comprises the step of showing the combined 3-dimensional graphical representation of the physical space and the computer network on a display wherein the display is a multitouch display.

In an embodiment of the present invention, the physical space is a building.

In an embodiment of the present invention, the method comprises the step of polling the computer network to obtain security information relating to the nodes.

In an embodiment of the present invention, the method comprises the step of polling the computer network to obtain security information relating to the nodes wherein the security information relates to a security breach.

In an embodiment of the present invention, the method comprises the steps of: polling the computer network to obtain security information relating to the nodes wherein the security information relates to a security breach; and graphically representing the security breach on the combined 3-dimensional graphical representation of the physical space and the computer network.

In an alternate embodiment of the present invention, a method of managing a computer network is provided. The method comprises the steps of: providing a computer network having a plurality of nodes; graphically representing the computer network in three dimensions; monitoring the computer network; and graphically representing a security event on the 3-dimensional graphical representation of the computer network.

In an embodiment of the present invention, the method comprises the steps of: graphically representing a physical space in three dimensions; and mapping the 3-dimensional graphical representation of the computer network onto the 3-dimensional graphical representation of the physical space.

In an embodiment of the present invention, the method comprises the step of polling the computer network for information relating to the computer network wherein the information relates to physical locations of the nodes in the computer network.

In an embodiment of the present invention, the method comprises the step of polling the computer network for information relating to the security of the computer network.

In an embodiment of the present invention, the method comprises the step of polling the computer network for information relating to the security of the computer network wherein the information relates to an attempt to breach the security of the computer network from outside the computer network.

In an embodiment of the present invention, the method comprises the step of polling the computer network for information relating to the security of the computer network wherein the information relates to an attempt to send malicious code from within the computer network.

In an embodiment of the present invention, the method comprises the step of polling the computer network for information relating to the security of the computer network wherein the information relates to an attempt to send malicious code from within the computer network to outside the computer network.

In an alternate embodiment of the present invention, a system for graphically representing a computer network is provided. The system comprises: a physical space; a computer network comprising a plurality of nodes residing within the physical space; a 3-dimensional modeler for graphically representing the physical space in 3-dimensions; a poller for obtaining information relating to the physical location of the nodes within the physical space; and a graphic generator for generating a combined 3-dimensional graphical representation of the physical space and the computer network.

In an embodiment of the present invention, the system comprises a display for showing the combined 3-dimensional graphical representation of the physical space and the computer network.

In an embodiment of the present invention, the system comprises a display for showing the combined 3-dimensional graphical representation of the physical space and the computer network wherein the display is a multitouch display.

In an embodiment of the present invention the physical space is a building.

In an embodiment of the present invention, the system comprises a poller interconnected with the computer network for obtaining security information relating to the nodes.

In an embodiment of the present invention, the system comprises a poller interconnected with the computer network for obtaining security information relating to the nodes wherein the security information relates to a security breach of the computer network wherein the security breach is graphically represented on the combined 3-dimensional graphical representation of the physical space and the computer network.

It is, therefore, an advantage to provide systems and methods for efficiently displaying and viewing network information from both an intrusion and/or an extrusion view, thereby displaying information regarding the network information in a manner that has contextual meaning to the individual.

A further advantage of the present invention is to provide systems and methods that utilize a polling mechanism to determine a network architecture.

A still further advantage of the present invention is to provide a polling mechanism that determines an initial status of a network and a real-time status of a network and all devices connected to the network.

In addition, an advantage of the present invention is to provide systems and methods for storing the information collected relating to the status of the network, whether initial or real-time, thereby allowing for efficient retrieval of the information for processing the data.

Additionally, an advantage of the present invention is to provide a visual representation of the information so that the information may be quickly and efficiently analyzed by an individual or provided with a preprogrammed response.

Moreover, an advantage of the present invention is to provide systems and methods for generating a 3-dimensional visual representation of a network architecture based on the location of nodes within the network, including computing devices such as computers, servers, routers, databases and the like.

A still further advantage of the present invention is to provide systems and methods for importing information relating to the physical structure of a building or buildings, or other physical space, location and/or locations containing the network and mapping and/or overlaying the 3-dimensional visual representation of the network architecture over the visual representation of the physical structure of the building or buildings, or other physical space, location and/or locations wherein the network resides.

Additional features and advantages of the present invention are described in, and will be apparent from, the detailed description of the presently preferred embodiments and from the drawings.

### BRIEF DESCRIPTION OF THE DRAWINGS

FIG. 1 illustrates a schematic representation of a building modeler in an embodiment of the present invention.

FIG. 2 illustrates a schematic representation of a polling mechanism in an embodiment of the present invention.

FIG. 3 illustrates a schematic representation of an aggregator of data storage in an embodiment of the present invention.

FIG. 4 illustrates a schematic representation of a 3-dimensional engine for rendering data elements for display in an embodiment of the present invention.

FIG. 5 illustrates a schematic representation of a management system for retrieving stored data elements relating to security sensors within a network in an embodiment of the present invention.

### DETAILED DESCRIPTION OF THE PRESENTLY PREFERRED

EMBODIMENTS

The present invention generally relates to the monitoring and management of a computer network. More specifically, the present invention relates to the monitoring and management of a computer network, wherein the architecture of the computer network is graphically represented 3-dimensionally. Moreover, the present invention relates to the monitoring and management of the network, wherein the 3-dimensional architecture of the network is mapped, overlaid or otherwise incorporated into a graphical representation of physical space and displayed on a visual display. In addition, the present invention relates to monitoring and management of the computer network, wherein a security event is graphically represented on the three-dimensional graphical representation of the computer network.

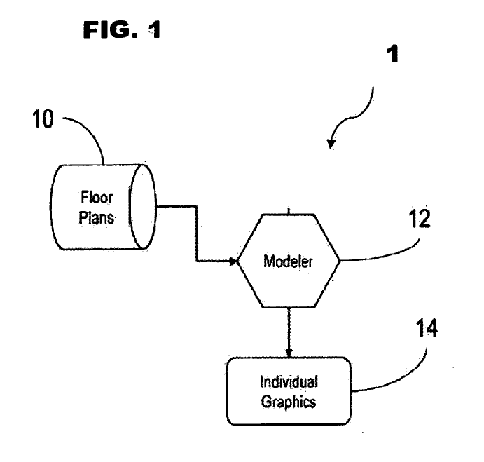

Referring now to the drawings, wherein like numerals refer to like parts, FIG. 1 illustrates a schematic representation of a modeling process 1 in an embodiment of the present invention. The modeling process 1 includes converting building floor plans into a 3-dimensional framework of a building. It should be noted that while the present invention describes the modeling of a floor plan of a building, any 3-dimensional representation of physical space may be accomplished, such as of one and/or more buildings, locations, geographical areas or the like. The present invention should not be limited as herein described.

As demonstrated in FIG. 1, floor plans 10 of a building or other physical space may be input into a modeler 12. The modeler 12 may manipulate the information contained in the floor plans 10 to produce individual graphics 14 of the floorplans 10, which may be used, as described below, to create one or more 3-dimensional graphical representations of the building or other physical space. The 3-dimensional graphical representation should, preferably, encompass the entirety of the physical space that contains all of the elements of the computer network. Alternatively, only a portion of the computer network may reside on or within the physical space represented by the 3-dimensional representation. Moreover, the physical space may include a logical space consisting of virtual nodes that are interconnected in a logical computing cloud.

The floor plans may be CAD drawings, or another similar graphical format, including but not limited to JPEG, GIF and bitmap files. The floor plans are then provided to the modeler to create the individual graphics utilized to create the 3-dimensional graphical representation of the building or other physical space. Once the floor plans are provided to the modeler 12, data points may be overlaid on the 3-dimensional graphical representation, thereby representing computer network information, as further described below.

Specifically, the modeler 12 may accomplish the converting of two-dimensional lines and points representing one or more floor plans into data points on an x, y, z axis to be read by and processed by the 3-dimensional engine or engines, as noted below.

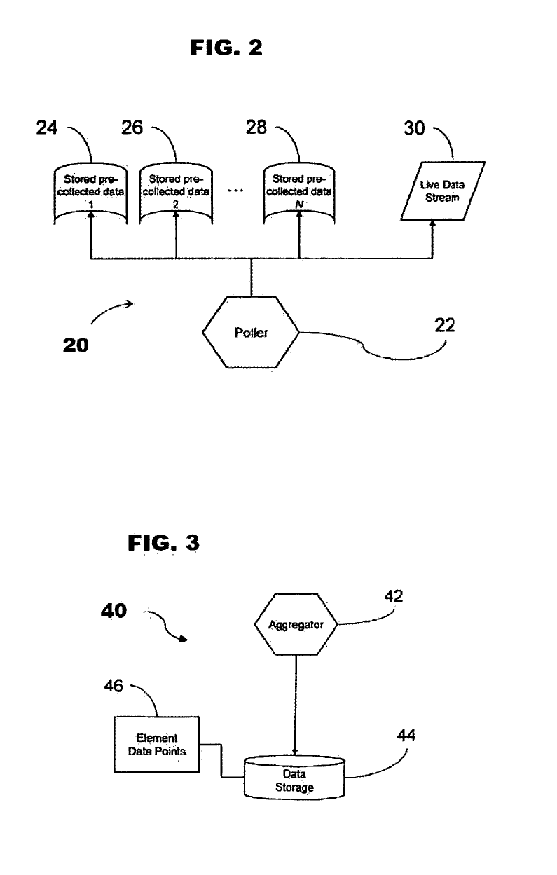

Referring now to FIG. 2, a system 20 for polling the network is provided. Specifically, the system 20 includes a poller 22 that is interconnected with the network at issue to gather information about the network. Specifically, the poller 22 taps into the data stream of the computer network to determine and specify the active electronic devices that are connected to the network. The poller 22 analyses the packets within the data stream of the network to extract data elements relating to each active electronic device (heretofore referred to as a “node”) on the network at issue. Specifically, the poller 22 communicates with the various nodes connected to the network. The nodes in the network may be switches, routers, and computing devices, such as desktop computers, laptop computers, PDAs, or other computing devices, and are capable of sending, receiving, or forwarding information over a communications channel within the network. In addition, firewalls are analyzed for information relating to the security of the computer network.

The poller 22 gathers and compiles information relating to each node on the network. Each individual piece of information is referred to as a “data element.”

Data elements may be compiled by the poller 22 by analyzing IP tuples, services offered, network names, and services accessed, for example. In addition, as the poller gathers indentifying information and a unique key for each node, it queries other standard information stores, such as LDAP, Active Directory, custom databases, remedy ticketing systems, various directory service solutions, and vulnerability scanners and/or reports. The poller should not be limited to a finite number of information stores and may be generally flexible in its configuration to add or query additional information. The invention should not be limited as herein described.

The interaction of the poller 22 with each of the nodes on the network allows the poller 22 to determine geographical and spatial locations of each of the nodes on the network. Other sources of data analyzed by the poller 22 include the Active Directory of the network at issue, wmi calls, external vulnerability data sources, current security device alerts and past security device alerts, for example. It should be noted that the poller 22 may access and analyze any source on the network to obtain information about the spatial relationship of the nodes on the network at issue, as well as security information relating to the network and the present invention should not be limited as herein described. The poller 22 compiles each of the data elements for each node on the network.

Referring to FIG. 2, sample data elements are shown, including “Stored Pre-collected Data 1 (24),” “Stored Pre-collected Data 2 (26),” to Stored Pre-collected Data N (28),” thereby representing a plurality of data elements relating to each node on the network at issue, and/or relating to the connectivity of each of the nodes with other nodes on the network at issue. Any number of data elements may be collected via the poller. Moreover, information relating to the live data stream (30) may further be compiled and stored along with the data elements.

The poller 22 may preferably have two distinct processes that allow it to gather information. First, the poller 22 listens to a live data stream using standard Libpcap libraries, decodes packets to extract specific information such as, but not limited to, IP addresses, services, NetBIOS name, and MAC addresses, for example, and finally associates these to a common key using the MAC address. IP addresses may change often. Therefore, MAC addresses offer a good stable key and they are more preferably utilized because they rarely change. Second, the poller 22 queries various data sources using standard protocols and techniques known to those of ordinary skill in the art, such as but not limited to: SNMP, WMI, SQL queries, LDAP queries, and SSH, for example, to gather information about the specific devices on the computer network.

Typically, individual data elements compiled by the poller 22 include, but are not limited to, IP addresses, ports, protocols, MAC addresses, MAC vendor, vulnerabilities, applications, services, roles, activities, flows, device to switch ports and geographical locations, hotfixes, patches, patch panels, rooms, jacks, zones, bulletins ACL and data access, events, serial numbers, secondary devices attached to primary devices, logged in user and information related thereto. Other data elements may be compiled, as apparent to one having ordinary skill in the art, and the present invention should not be limited as herein described.

Referring now to FIG. 3, an aggregation system 40 is provided. The aggregation system 40 includes an aggregator 42 that receives each of the data elements relating to each of the nodes on the computer network. Specifically, the data elements for each of the nodes on the network, as well as information relating to the live data streams of the network, are stored on a relational database 44. The data elements in the database 44 are cross-linked and indexed to provide both current and historical data relating to the network. Moreover, the aggregator 42 also pre-stages the data elements and the relationships of the data elements for quick access by the 3-dimensional graphical engine, as described below.

The aggregator 42 is preferably responsible for correlating disparate data elements for common long-running calculations. The 3-dimensional engine or engines, as noted below, allow for the quick display of large amounts of visual data. Some of the information, for example, include information that consist of hundreds or thousands of possible ties over a long span of time. The aggregator preferably continuously calculates and re-calculates associations to give an immediate up-to-date view of the current status of a device. Due to the secure nature of the present invention, the aggregator 42 provides a complete data environment immediately as opposed to taking several minutes to compute. This is an advantage because malicious attacks on a network typically take seconds to accomplish, so an immediate notification via the present invention may be crucial for protecting the network.

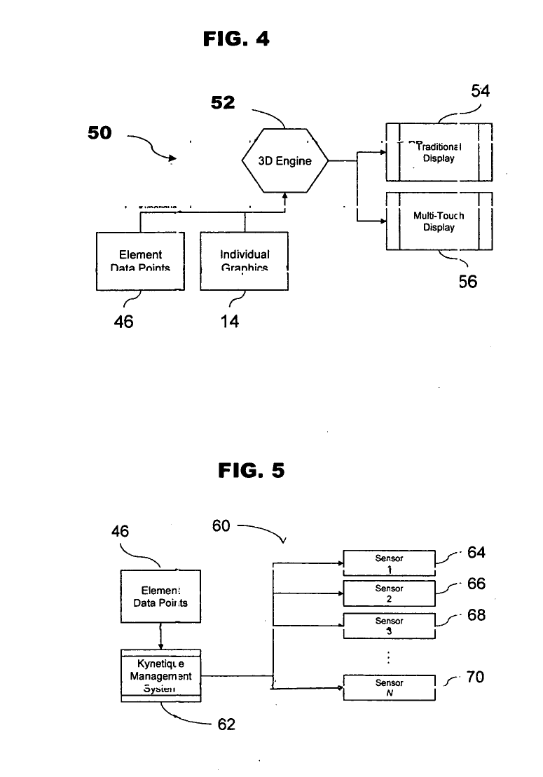

Referring now to FIG. 4, a system 50 for compiling the data elements of each node and the 3-dimensional graphics of the building or other physical space is provided. The data elements for each node on the network, referred to as “Element Data Points” 46, as compiled and stored previously as shown in FIG. 3, and the individual graphics 14, consisting of the 3-dimensional graphical representation of the building or other physical space, as generated previously and shown in FIG. 1, are fed to the 3-dimensional engine 52. The 3-dimensional engine 54 joins the data elements for each node, including the geographical and spatial location information for each node, with the 3-dimensional graphical representation of the building or other physical space to form a combined 3-dimensional graphical representation, including the building or other physical space and the network and locations for each node and the connectivity of each node on the network. Symbols may be utilized to show each node, and lines may be utilized to show how each node is connected to the network, or otherwise interconnected to each other.

The combined 3-dimensional graphical representation, including the building or other physical space, the computer network, the locations of each node and connectivity of each node on the network may be displayed via a traditional display 54. Alternatively, the combined 3-dimensional graphical representation may be displayed on, for example, a multitouch display 56, whereby information for the building or other physical space and the network at issue may be retrieved by touching the display on the graphical symbols. Of course, the combined 3-dimensional graphical representation may be viewed via any traditional viewer, and further may be printed for viewing as well. The present invention should not be limited as herein described.

Referring now to FIG. 5, a management and control system 60 is provided. The management and control system 60 includes a manager 62 that watches the network and the stored data elements to determine either historical or current network security issues relating to the network. Specific data elements may be grouped into various policies and continuously watched as the information is polled via the systems and methods provided herein. Moreover, sensors (illustrated as “Sensor 1” (64), “Sensor 2” (66), “Sensor 3” (68) to “Sensor N” (70), as shown in FIG. 5) may be utilized to sense when security breaches (heretofore “events”) occur or are attempted on the network. The combined 3-dimensional graphical representation may be utilized to show where on the network the security breach has occurred, is occurring, or is being attempted.

Security events may relate to unauthorized attempts to access the computer network and attempts to add malicious code to a node or nodes within the computer network, either from within the network or outside the network. Moreover, security events may further relate to attempts to send malicious code from a node within the computer network to one or more devices within the computer network and/or attempts to send malicious code from a node within the computer network to outside the computer network. Of course, any type of security event or breach is contemplated by the present invention and the invention should not be limited as herein described.

### EXAMPLE

A typical scenario may play out as follows. A user, “John Smith,” may utilize a desktop computer that may be located on the second floor of a building in cube 23, jack 23A. John Smith may download a program from the Internet and launch it. The program may have malicious code that compromises his computer. John Smith's computer may then, with or without John Smith's knowledge, attempt to compromise other computers on his computer network.

In this scenario but without the benefits of utilization of the present invention, there may be several ways an administrator may be alerted to this malicious compromise of the computer network—through logs or alerts. However, these logs and/or alerts are typically spread across several functional domains to include Network, Infrastructure, Security and Desktop. However, the one or more logs and/or alerts may not be sufficient to specify an issue, a location of attack, and/or other necessary information to stop the malicious compromise of the computer network.

The system and method of the present invention compiles events and data across functional domains into one 3-dimensional visual representation. This visual representation, which maybe displayed via a typical visual display, or a multitouch display, or via any other display apparent to one having ordinary skill in the art, provide important contextual information. The 3-dimensional visual representation displays John

Smith logged into the desktop device on the second floor, cube 23, jack 23A, and would show the web action, the download action, the launch action, and the subsequent computer-to-computer action. Moreover, the same visual representation would show that John Smith has a history of downloading software, which cause help desk tickets to be generated. The present invention automatically and immediately compiles what would normally take a great deal of time, manual correlation, a plurality of administrators across several functional domains to complete. The present invention then immediately displays the computer network and pinpoints any potential serious security breach.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. A method for graphically representing a computer network comprising the steps of:
providing a 3-dimensional modeler;
inputting information about a physical space into the modeler for graphically representing the physical space in 3-dimensions;
providing a computer network comprising a plurality of nodes, the plurality of nodes residing within the physical space;
polling the computer network to obtain information relating to the physical location of the nodes within the physical space; and
generating a combined 3-dimensional graphical representation of the physical space and the computer network.

2. The method of claim 1 further comprising the step of:
showing the combined 3-dimensional graphical representation of the physical space and the computer network on a display.

3. The method of claim 1 further comprising the step of:
showing the combined 3-dimensional graphical representation of the physical space and the computer network on a display wherein the display is a multitouch display.

4. The method of claim 1 wherein the physical space is a building.

5. The method of claim 1 wherein the physical space is a logical space wherein the logical space is a representation of virtual nodes in a logical computing cloud.

6. The method of claim 1 further comprising the step of:
polling the computer network to obtain security information relating to the nodes.

7. The method of claim 1 further comprising the steps of:
polling said computer network to obtain security information relating to the nodes wherein the security information relates to a security breach; and
graphically representing the security breach on the combined 3-dimensional graphical representation of the physical space and the computer network.

8. A method of managing a computer network comprising the steps of:
providing a computer network having a plurality of nodes;
graphically representing the computer network in three dimensions;
monitoring the computer network; and
graphically representing a security event on the 3-dimensional graphical representation of the computer network.

9. The method of claim 8 further comprising the steps of:
graphically representing a physical space in three dimensions; and
mapping the 3-dimensional graphical representation of the computer network onto the 3-dimensional graphical representation of the physical space.

10. The method of claim 8 further comprising the step of:
polling the computer network for information relating to the computer network wherein the information relates to physical locations of the nodes in the computer network.

11. The method of claim 8 further comprising the step of:
polling the computer network for information relating to the security of the computer network.

12. The method of claim 8 further comprising the step of:
polling the computer network for information relating to the security of the computer network wherein the information relates to an attempt to breach the security of the computer network from outside the computer network.

13. The method of claim 8 further comprising the step of:
polling the computer network for information relating to the security of the computer network wherein the information relates to an attempt to send malicious code within the computer network.

14. The method of claim 8 further comprising the step of:
polling the computer network for information relating to the security of the computer network wherein the information relates to an attempt to send malicious code from within the computer network to outside the computer network.

15. A system for graphically representing a computer network comprising:
a physical space;
a computer network comprising a plurality of nodes residing within the physical space;
a 3-dimensional modeler for graphically representing the physical space in 3-dimensions;
a poller for obtaining information relating to a physical location of said nodes within the physical space; and
a graphic generator for generating a combined 3-dimensional graphical representation of the physical space and the computer network.

16. The system of claim 15 further comprising:
a display for showing the combined 3-dimensional graphical representation of the physical space and the computer network.

17. The system of claim 15 further comprising:
a display for showing the combined 3-dimensional graphical representation of the physical space and the computer network wherein the display is a multitouch display.

18. The system of claim 15 wherein the physical space is a building.

19. The system of claim 15 further comprising:
a poller interconnected with the computer network for obtaining security information relating to the nodes.

20. The system of claim 15 further comprising:
a poller interconnected with the computer network for obtaining security information relating to the nodes wherein the security information relates to a security breach of the computer network wherein the security breach is graphically represented on the combined 3-dimensional graphical representation of the physical space and the computer network.
